(19) United States
(12) Patent Application Publication
(10) Pub. No.: US 2003/0074328 A1
(43) Pub. Date: Apr. 17, 2003

(54) System and method for conducting a financial transaction using a communication device

(76) Inventors: Steven Schiff, Stamford, CT (US); Joanna Sandorffy, Seattle, WA (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/266,629

(22) Filed: Oct. 9, 2002

Related U.S. Application Data
(60) Provisional application No. 60/327,904, filed on Oct. 9, 2001.

(51) Int. Cl. G06F 17/60

(52) U.S. Cl. 705/75

(57) ABSTRACT

A method and system are disclosed for conducting a financial transaction using a communication device. In accordance with exemplary embodiments, the system includes a communication device for transmitting user identification information and a unit identification number that is associated with a financial transaction device that is contacted via the communication device. The system includes a financial transaction system for receiving the user identification information and the unit identification number from the communication device. The financial transaction system is contacted using an access calling number. The financial transaction system is configured to transmit financial information associated with the user to the financial transaction device associated with the unit identification number. A financial transaction is conducted with the financial transaction device in the absence of use of a financial account access card, upon receipt by the financial transaction device of the financial information associated with the user.

This application claims priority under 35 U.S.C. § 119 to U.S. Provisional Application No. 60/327,904, filed on Oct. 9, 2001.

### BACKGROUND

1. Field of the Invention

The present invention relates to Electronic Funds Transfer machines and other financial transaction devices. More particularly, the present invention relates to a system and method for conducting a financial transaction using a communication device, such as a cellular telephone, Personal Digital Assistant (PDA), or the like, in conjunction with a financial transaction device, such as an Automated Teller Machine (ATM), Point of Sale (POS) machine, or the like.

2. Background Information

Point of Sale (POS) machines, Automated Teller Machines (ATMs), and other like financial transaction devices are widely available and allow users to perform a variety of financial and non-financial transactions, such as, for example, withdrawing cash, verifying funds, and purchasing goods and services. For those who have access to these financial transaction devices, they can be a convenient and simple way to conduct everyday financial transactions. These machines offer users ubiquitous and immediate access to their money to perform financial transactions, such as, for example, accessing cash, transferring funds, or purchasing goods at a merchant. Such convenience allows liquidity of assets in an immediate and gratifying manner.

The typical use of financial transaction devices, such as ATMs and POS machines, has several drawbacks. For example, access to the machines is limited to those who can interact with the machines. Several segments of the general population cannot interact with these machines in the predetermined ways that the mainstream population does. For example, a visually impaired person cannot see the various components of the machine required to conduct a transaction. Without being able to see where to insert their card or read the display, ATMs and POSs are not easily accessible to the visually impaired, nor do they offer an independent usage scenario. For example, in the case of a POS transaction, a signature is required to complete the purchase. Either form of signature, off-line or online, proves difficult for a visually impaired user. For an off-line signature, the merchant can place the paper and pen in front of the user and align a special signature-device over the portion of the receipt requiring a signature. For an on-line signature, the same sequence can occur. In either case, the visually-impaired user is relying on someone else to help the individual to conduct the financial transaction.

One example of a visually-impaired person using an ATM today is someone who tends to use or feels comfortable using only one specific machine for cash withdrawals. This may be because the user has learned the interaction cues and menu sequences on that one, specific machine. Rather than experiencing the fear of the unknown, this user has attained a comfort level and chooses to only patron the one ATM.

Although it is an independent activity to use an ATM, one which many sighted people may even take for granted, a visually-impaired person is essentially limited in the scope of some of their financial transactions to the ATMs with which they are comfortable using. Taking this scenario one step further, consider when a visually-impaired person travels. There are more than 300,000 ATMs in this country. While most people know they can access their money from virtually anywhere, a visually-impaired person may only go to “his/her ATM” before travelling and withdraw enough money for the person's entire trip. Not only is it inconvenient for the individual, but it may actually be considered dangerous to carry such a large amount of cash. This is one of many reasons that some of the visually impaired are uncomfortable using an ATM machine. In addition, the “convenience” factor of an ATM is negated by the fact that a visually impaired person may be essentially limited to using 1 out of 300,000 ATM machines.

A portion of those people who do not operate in the traditional world of financial institutions is the lower-income population. Some of the reasons that lower-income individuals do not interact with financial institutions include the general mistrust of financial institutions, minimum balance requirements and associated fees, fear of the unknown, or even lack of financial literacy. Therefore, since one must have an account with a financial institution to withdraw money at an ATM or purchase goods using a POS, these financial transaction devices are limited to those populations that have financial accounts.

Estimates place approximately 13% of the general population as being outside the traditional financial institution economy. According to the Federal Reserve's triennial survey of Consumer Finances in 1995, 13% of households (roughly 13 million of them) had no bank accounts of any kind and 15% did not own checking accounts. Consequently, ATMs, POS machines, and other financial transaction devices are inaccessible, either by choice or often not by choice, to 13 million families in the United States alone.

Another consequence of not having access to traditional financial services is that these populations, such as the visually impaired and lower-income, are forced to operate in the cash-only economy. The cash-only economy has extremely high fees for transactions, such as service fees and high lending rates, which actually cost more than the equivalent in the traditional world of financial services. Although the cash-only service providers argue that these fees are needed to cover the risk of handling cash, the unfortunate truth is that the people who can afford it the least are paying the most.

An unfortunate consequence of operating in the cash-only economy is that a person cannot build a credible credit history. Since the cash-only vendors cannot and do not track their customers, there is no way to follow the history of their financial transactions. Without a credit history, individuals are unable to, for example, get a loan to buy a house. Therefore, a cash-only consumer, who may not even be so by choice, is not necessarily saving, planning or spending in a fiscally responsible manner.

Unfortunately, providing the low- or un-sighted, or even the lower-income, with access to goods and services has been difficult for many businesses and service providers. Market realities are such that finding these niche populations and determining how to service them have been cost-prohibitive. Recognizing that these populations are not being served properly, specifically for the disabled, laws and regulations are being implemented with the best interests of these populations in mind. These upcoming disability regulations affect nearly 300,000 ATMs in the United States.

When these regulations are implemented, cost effective compliance will be determined by each company and industry. For example, one proposed solution to assist the blind is to retrofit each ATM with a headset jack. A blind or similarly-disabled individual would then plug their headset into the headset jack in the ATM and listen to recorded instructions provided by the ATM that guide the individual through the process of conducting a financial transaction at the ATM. Retrofitting ATMs to include such accessibility features can cost between $1000 and $2000 per machine. A new ATM can cost between $4000 and $5000. With 300,000 ATMs currently in use, the price tag for merely retrofitting existing ATMs could cost the banking industry between $300,000,000 and $600,000,000. The solutions are costly and, ultimately, every machine will need a compliant solution. If the cost of compliance is too high, the financial transaction devices may be “grand-fathered in,” leaving the disabled and low-income without convenient access to many, if not most, machines. In addition, current proposed solutions do not consider the individualized issues that different visually-impaired users may have. For example, the pre-recorded audio files (accessed via the headset) may not be able to provide assistance in all scenarios. Additionally, such solutions rely on audible cues that may be misinterpreted.

In addition to a realistic, comforting and cost-efficient solution, many impaired and impoverished users may not see a reason to engage in traditional financial transactions. By simply offering a new medium for conducting financial transactions, but not educating the user as to why or how to conduct the transactions, the solutions become essentially meaningless. Consequently, financial literacy is also greatly needed for many segments of the population.

The government currently spends hundreds of thousands of dollars annually to teach people how to save and invest their money for the future. Unfortunately, the populations who may need the training the most, such as the visually impaired and the lower income, often do not have access to such programs. If they do receive such education, it is often intangible or impractical. For example, sitting in a classroom for several hours one time or receiving emails with hints on saving money, may not provide a meaningful context or tangible reminder for saving their money. This is often referred to as “off-line” education. While the content may be meaningful, the context is too far removed from their everyday lives to make an impact on their behavior. Additionally, this off-line education may only come as a means to an end. For example, many people receive a crash course in financial planning when they are applying for a mortgage. Since the course is a requirement to receiving money for a new house, many people attend such a course, but may retain little of the information, as the course is simply a means to qualify for a much-needed mortgage.

It would be desirable to enable particular users, such as the visually impaired and lower-income populations, to engage in financial and other electronic transactions that they would otherwise be unable to conduct. By engaging in such financial transactions, the visually impaired and lower-income can be empowered to participate in an aspect of mainstream society that is usually inaccessible to them. Additionally, such a solution serves the general population as well, allowing them to conduct financial transactions in a more efficient and convenient manner.

### SUMMARY OF THE INVENTION

A method and system are disclosed for conducting a financial transaction using a communication device. In accordance with exemplary embodiments of the present invention, according to a first aspect of the present invention, a system for conducting a financial transaction using a communication devices includes a communication device for transmitting user identification information to identify a user and for transmitting a unit identification number. The system includes a financial transaction system for receiving the user identification information and the unit identification number from the communication device. The financial transaction system is contacted using an access calling number. The system also includes a financial transaction device that communicates with the financial transaction system. The unit identification number is associated with the financial transaction device. The financial transaction device is contacted via the communication device. The access calling number enables communication with the financial transaction device using the communication device. The financial transaction system is configured to transmit financial information associated with the user to the financial transaction device associated with the unit identification number. A financial transaction is conducted with the financial transaction device in the absence of use of a financial account access card, upon receipt by the financial transaction device of the financial information associated with the user.

According to a second aspect of the present invention, a method for conducting a financial transaction using a communication device comprises the steps of: (i) contacting a financial transaction system associated with a financial transaction device via the communication device, wherein the financial transaction system is contacted using an access calling number, and wherein the access calling number enables communication with the financial transaction device using the communication device; (ii) transmitting user identification information from the communication device to the financial transaction system to identify a user; (iii) transmitting a unit identification number associated with the financial transaction device from the communication device to the financial transaction system; (iv) transmitting financial information associated with the user from the financial transaction system to the financial transaction device associated with the unit identification number; and (v) conducting a financial transaction with the financial transaction device in the absence of use of a financial account access card, upon receipt by the financial transaction device of the financial information associated with the user.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a system for conducting a financial transaction using a communication device, in accordance with an exemplary embodiment of the present invention.

FIGS. 2A and 2B are a flowcharts illustrating steps for user interaction with a financial transaction device in an absence of a financial account access card, in accordance with an exemplary embodiment of the present invention.

### DETAILED DESCRIPTION OF THE PREFERRED EMBODIMENTS

A system and method are disclosed for conducting a financial transaction using a communication device. According to exemplary embodiments, a financial transaction device includes an identification logo (ID logo), an access telephone number (ATN), and a distinct unit identification number (UIN). The ID logo, the ATN and the UIN are in a format that can be sensed tactilely, such as Braille or raised characters, and are in a readily accessible and consistent location on the financial transaction devices. Accordingly, a visually-impaired individual can use the financial transaction device without assistance from another individual. In addition to offering independence and valuable life-skills to the visually-disabled and low income segments of the population, exemplary embodiments of the present invention comply with proposed accessibility regulations.

According to exemplary embodiments, financial transactions are conducted through a financial transaction system that is accessed by the ATN located locally to the financial transaction device. The financial transaction system also includes a database that stores user information.

According to exemplary embodiment, once the user has located a financial transaction device, the individual calls the ATN to communicate with an interactive voice response (IVR) system with the user's communication device. Once in communication, the user inputs the UIN of the financial transaction device. The IVR can be comprised of a standard set of instructions that is consistent for all financial transaction devices. By maintaining consistency and predictability, the visually-impaired user, and others as well, can attain a comfort level with each subsequent use.

However, the IVR can be customizable, if desired. According to exemplary embodiments, if, for example, a user always performs the same transaction, the user can set up the IVR to perform only that transaction. This can save the user time at the financial transaction device, thereby increasing efficiency. The user can also customize the IVR by, for example, setting different security levels based on transaction type or amount. For example, the user can set up the IVR to add an extra personal identification number (PIN) if the transaction is more than, for example, $500 or any desired amount. The convenience of customization increases the comfort level of using these financial transaction devices, especially for those who are new to financial transactions, such as, for example, the visually impaired or the lower-income.

According to exemplary embodiments, the IVR can offer extended services to the user, such as, for example, customizable features and help, including multiple languages, saved transactions, and educational assistance, such as financial literacy tutorials. The information is presented to the user in a contextual and re-enforceable manner. For example, while conducting a financial transaction, a user of the present invention can listen to a short lesson on saving their money. When the individual deposits money, they can, for example, receive bonus minutes on a phone card or the ability to wire money without a fee. By teaching individuals how, why, and when to conduct meaningful financial transactions, and offering additional incentives, individuals can be educated, empowered and rewarded at the same time. Seemingly small incentives offered consistently and conveniently can help to reinforce the positive behavior of financial literacy and planning. The financial education provided according to exemplary embodiments of the present invention is a lower-cost, more practical, and online (daily) solution targeted at populations who need such guidance.

According to exemplary embodiments, once the UIN is input, the financial transaction system communicates with the financial transaction device to transmit the information associated with the user to the financial transaction device. The user can then interacts with the financial transaction device either via the communication device (e.g., using the IVR) or, for example, a keypad of the financial transaction device to perform a financial transaction.

According to an alternative exemplary embodiment, a financial transaction can be remotely set up in advance. For example, a user can call the IVR from the privacy of the individual's home, set up the financial transaction for a later date, and set, for example, a one-time password for that financial transaction. Since the financial transaction system would have most of the user's information entered during this registration process, the user would then enter the ATN and the UIN of the financial transaction device to be accessed. When the user is ready to conduct the financial transaction, the individual would travel to the selected financial transaction device and use the temporary password that the individual set up.

According to exemplary embodiments, the remote access feature can be used by additional users and in additional locations. For purposes of illustration and not limitation, a family member in, for example, the United States (or any other location) can set up a financial transaction for a family member in, for example, Mexico (or any other different location). The family member in Mexico would call the family member in the United States with the necessary access information, including the ATN, the UIN of the financial transaction device to be used, and a requested temporary password for the financial transaction. The family member in the United States can dial the ATN and use the IVR to set up the financial transaction. When notified that the financial transaction is ready for the family member in Mexico, the family member in Mexico can retrieve the money using the temporary password.

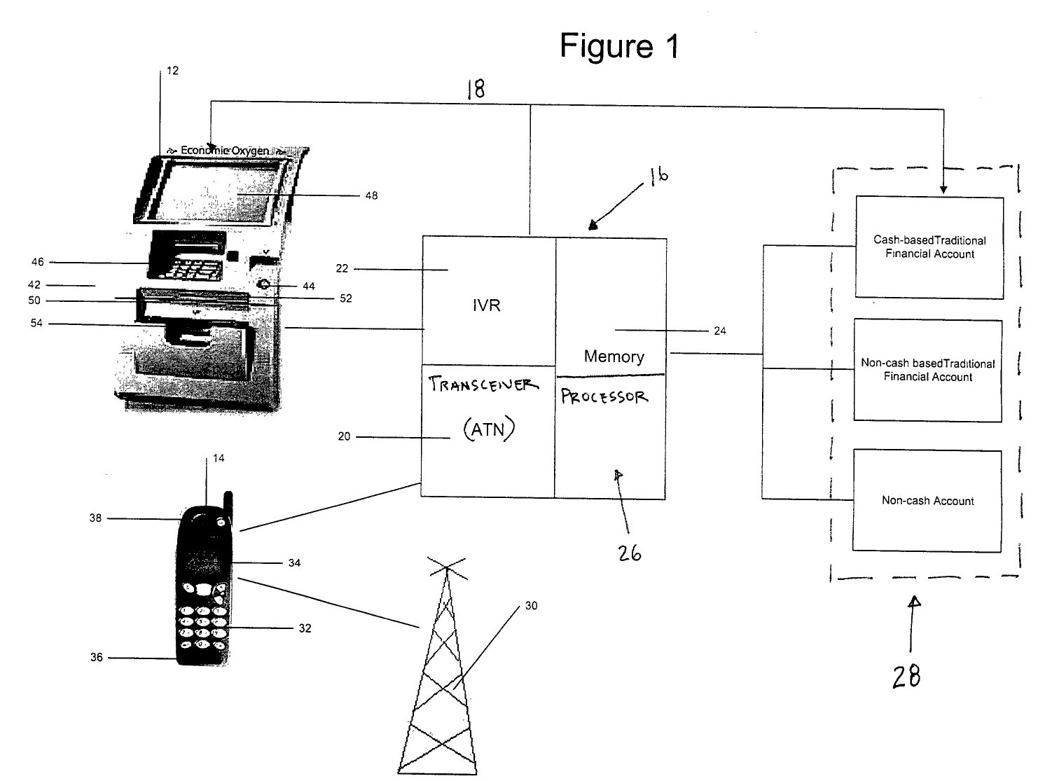

These and other aspects of the present invention will now be described in greater detail. FIG. 1 is a block diagram illustrating a system for conducting a financial transaction using a communication device, in accordance with an exemplary embodiment of the present invention. The system includes a communication device 14 for transmitting user identification information to identify a user and for transmitting a unit identification number. The communication device 14 can be any type of communication device that allows a user to remotely communicate information, such as, for example, a cellular telephone, a satellite telephone, a personal digital assistant (PDA) having telephony capability, wireless transaction systems, BLUETOOTH™-enabled telephones, land-line telephones, beepers, pagers, two-way radios, or any other wireless or wired communication device. For example, the communication device 14 can be any type of cellular phone that can include a keypad 32, a display 34, a microphone 36, and a speaker 38.

As used herein, “user identification information” can be any type of information that uniquely identifies a user. For example, user identification information can be a personal identification number (PIN), a calling party identification associated with the communication device (e.g., a cellular or other telephone number of the communication device 14, the Caller ID number associated with a telephone or the like), a subscriber number (e.g., an alphanumeric number) that is unique to the user, biometric information (e.g., voice pattern, retinal pattern, fingerprint or the like) unique to the user, or any other type of information that uniquely identifies a user and that can be communicated via the communication device 14. Depending upon the type of user identification information, the communication device 14 can be configured to communicate such identifying information (e.g., using the keypad 32 to enter the subscriber number, using the microphone 36 to input a user's voice for voice recognition, attaching or including a retinal or fingerprint scanner to the communication device 14 to communicate such biometric information, and the like).

According to exemplary embodiments, the system includes a financial transaction system 16 for receiving the user identification information and the unit identification number from the communication device 14. The system also includes at least one financial transaction device 12 that communicates with the financial transaction system 16. The financial transaction device 12 can be any device or machine that allows a user to conduct a financial transaction of any type. For example, the financial transaction device 12 can be an automated teller machine (ATM), a point-of-sale (POS) device, or the like. For purposes of illustration and not limitation, the financial transaction system 12 can be an ATM machine that includes a keypad 46, a display 48, a cash dispenser 50, a receipt dispenser 52, and, optionally, a deposit slot 54.

The financial transaction system 16 communicates with the financial transaction device 12 either via, for example, a telecommunication network 18 or through a direct (e.g., land-line) connection between the financial transaction system 16 and the financial transaction device 12. The financial transaction system 16 can include a transceiver 20, or any other type of communication element, that can communicate electrical information between the financial transaction system 16 and the financial transaction device 12 and between the financial transaction system 16 and the communication device 14. For example, the transceiver 20 can be a modem or the like. The transceiver 20 is adapted to receive calls from the communication device 14 and for communicating over the telecommunication network 18. For example, a cellular phone signal can be relayed by cellular transmitter/receiver tower 30 to the financial transaction system 16 via the transceiver 20.

The financial transaction system 16 also includes an interactive voice response (IVR) module 22. IVR module 22 can be any type of IVR system that allows user to enter commands or information and receive information in response to voice messages The financial transaction system 16 can also include a memory 24 and a processor 26 for executing commands. The memory 24 can be any type of computer memory or electronic storage medium, such as, for example, read-only memory (ROM), random access memory (RAM), compact disc read-only memory (CDROM), electro-optical memory, magneto-optical memory, or the like. The memory 24 can store a program or other software that can be executed by the processor 26 or used to control the processor 26. The processor 26 can be any type of processor, such as, for example, a microprocessor, a microcontroller, or the like. However, financial transaction system 16 can be implemented using any combination of hardware, software, or firmware.

The financial transaction system 16 is configured to access the financial information associated with the user from at least one financial information database. Thus, the processor 26 can retrieve information from or store information to, for example, a database 28 that is located either locally or remotely to the financial transaction system 16. If located remotely, the database 28 can be connected to the financial transaction system 16 using any type of connection that is capable of communicating electrical information (e.g., a wire, cable, network (e.g., Ethernet) connection, or the like). The database 28 can be any type of computer storage media, such as, for example, read-only memory (ROM), random access memory (RAM), compact disc read-only memory (CDROM), electro-optical memory, magneto-optical memory, or the like.

According to exemplary embodiments, the database 28 can store financial information associated with the user. For example, the database 28 can store a user name, user contact information (e.g., address, telephone number, and the like), financial account information (e.g., a bank account number of the user or any other type of financial account information), and stored value account information. The financial account information can have, for example, multiple sub-accounts and be associated with a non-traditional holding entity. The database 28 can also store financial institution information, such as, for example, dedicated data line numbers and other vital exchange information. However, the database 28 can store any type of information that can be used as part of a financial transaction conducted by the user. Thus, the financial transaction system 16 can be associated with a financial institution, a POS retailing transaction network, a frequent-flier point information system, or any other type of entity with which a user can conduct a financial transaction.

The financial transaction system 16 is contacted using a unique access calling number that is associated with the financial transaction system 16. According to an exemplary embodiment, the access calling number is an access telephone number (ATN) 42 that enables communication with the financial transaction device 12 using the communication device 14. However, the access calling number can be, for example, an Internet Protocol (IP) address for Internet-enabled communication devices 14, or any other type calling number or address that can be used to communicate with the financial transaction device 12. In addition, each financial transaction device 12 has an associated unit identification number (UIN) 44 that is unique to each financial transaction device 12. The UIN can be any sequence of alphanumeric characters that can uniquely identify a financial transaction device 12. Both the access calling number and the unit identification number are located locally to (e.g., on) the financial transaction device 12. According to an exemplary embodiment, the unit identification number and the access calling number comprise tactile-sensed structures, such as, for example, Braille, that can be understood by, for example, visually-impaired individuals.

Thus, according to exemplary embodiments, each financial transaction device 12 can be provided on or adjacent to its housing an indication of both the ATN 42 for the financial transaction system 16 and a UIN 44 of the financial transaction device 12. A user contacts the financial transaction device 12 via the user's communication device 14 using the ATN 42 associated with the financial transaction device 12. The user can communicate with the financial transaction device 12 either directly, or through the financial transaction system 16. The financial transaction system 16 is configured to verify an identity of the user using the user identification information that is provided (either automatically or manually) to the financial transaction system 16. Thus, the financial transaction system 16 can be configured to process the user identification information, e.g., by matching the subscriber number with a subscriber number stored in a memory, matching the Caller ID number of the communication device 14 with telephone number stored in memory, comparing the user's voice print with a sample of the user's voice print stored in memory, and the like. Processing biometric information is described in, for example, U.S. Pat. Nos. 6,424,249, 6,345,761, and 6,219,439, the entire disclosures of which are hereby incorporated herein by reference. Verifying identities using Caller ID information is described in, for example, U.S. Pat. No. 6,324,271, the entire disclosure of which is hereby incorporated herein by reference. For biometric information, the financial transaction system 16 can be configured to register a biometric sample of the user, for example, storing the biometric sample (e.g., a voice print) in memory 24 for later retrieval and matching. Upon verification of the user's identify, the financial transaction system 16 is configured to access or otherwise retrieve the financial information associated with the user based on the user's identify or, alternatively, based on the identification of the communication device 14 (e.g., the telephone number of the communication device 14).

The financial transaction system 16 is also configured to associate the UIN 44 with a host identification to identify the financial transaction device 12 to which to transmit the financial information that has been retrieved. Consequently, the financial transaction system 16 is configured to transmit the financial information associated with the user to the financial transaction device 12 associated with the UIN 44. The user can then conduct a financial transaction with the financial transaction device 12, for example, in the absence of a financial account access card, upon receipt by the financial transaction device 12 of the financial information associated with the user. The user can conduct the financial transaction with the financial transaction device 12 using the communication device 14. For example, the user can use the communication device 14 to conduct the financial transaction by entering a dual tone multi-frequency (DTMF) sequence into a keypad (e.g., keypad 32) of the communication device 14 or entering voice commands into a microphone (e.g., microphone 36) of the communication device 14 for the IVR module 22. Alternatively, the user can conduct the financial transaction with the financial transaction device 12 using the financial transaction device 12 (e.g., by entering information using keypad 46).

According to exemplary embodiments, the user can conduct any type of financial transaction using the financial transaction device 12. For example, the financial transaction device 12 can be configured to allow the user to withdraw cash from the financial transaction device 12, to allow the user to determine a balance of a financial account, to allow the user to purchase at least one good (e.g., lottery tickets, telephone time, or any other good) or service (e.g., identity verification services, such as electronic notary public services), to allow the user to access a store of value, to deposit money, to make a balance inquiry, to transfer funds, to access loyalty points, to obtain a credit history, to communicate with the financial institution, or to conduct any other type of financial transaction. According to exemplary embodiments, to access a store of value the communication device 14 is configured to provide, by the user, a user account security identification associated with the store of value, for example, a PIN or any other type of unique user account information. According to exemplary embodiments, the store of value can be a bank account, a cash-based non-bank account, or a non-cash-based account (e.g., prepaid telephone account, a frequent flier account, or any other type of non-cash-based account from which a user can retrieve, for example, cash or conduct a financial transaction). For non-cash-based accounts, the financial transaction system 16 is configured to convert the value of the non-cash-based account into a cash equivalent (e.g., converting frequent flier miles to the equivalent amount of cash). Thus, a user can build up a store of value in a non-cash-based account, such as a frequent flier program, and then use exemplary embodiments of the present invention to convert the store of value and retrieve the cash equivalent value from those accounts.

Additionally, the user can call the financial transaction system 16 to find the location of a system-compatible financial transaction device 12, for example, the address, directions, and a summary of where the ATN and UIN are located on the financial transaction device 12. Alternatively, a user can use the communication device 14 to register or update user information, such as, for example, contact information, and financial account information that is stored in database 28 of the financial transaction system 16.

According to an alternative exemplary embodiment, the financial transaction device 12 comprises a point-of-sale (POS) device. The POS device can be used by the user to conduct a POS transaction (e.g., purchasing a good or service). According to this alternative exemplary embodiment, the POS device is configured to enter a transaction amount and a communication device access number and configured to forward the transaction amount and the communication device access number to the financial transaction system 16. The financial transaction amount can comprise at least one of price information, a list of goods and/or services, a payee name, a date, a time, a location, an invoice number, and the like. The financial transaction system 16 is configured to contact the communication device 14 associated with the communication device access number for transaction authorization, to contact a financial institution processor for a transaction verification, and to issue a transaction approval to the POS device, after receiving a transaction authorization from the communication device 14 and after receiving the transaction verification from the financial institution processor. Thus, the user can use the communication device 14 to initiate, conduct, and authorize the POS transaction.

According to this alternative exemplary embodiment, to authorize the POS transaction, the financial transaction system 16 is configured to transmit to the communication device 14 at least one of a transaction amount, a merchant identifier, a date, a time, and a remaining balance in a financial account associated with the user. This information can be displayed to the user on, for example, the display 34 of the communication device 14, or spoken to the user by the IVR module 22. The transaction authorization can comprise, for example, a PIN, a voice print, a predetermined verbal response from the user, or the like.

The financial institution processor is configured to forward the transaction verification from the financial institution processor to a POS switch, and the POS switch is configured to forward the transaction verification from the POS switch to the financial transaction system 16. The POS switch can be, for example, a network interface (e.g., a router) or any other type of interface that allows communication between the financial institution processor and the financial transaction system 16. To perform the POS transaction, the financial institution processor is configured to debit a financial account associated with the user for a financial transaction amount (e.g., the amount of the purchase), and to credit a financial account associated with a merchant for the financial transaction amount (e.g., the amount of the purchase). To complete the POS transaction, a cash register can be associated with the POS device. The cash register can be configured to enter at least one of the transaction amount and the communication device access number. This information can then be transmitted to the financial transaction system 16. The financial transaction system 16 is configured to forward the transaction amount from the financial transaction system 16 to a POS switch, and the POS switch is configured to forward the transaction amount from the POS switch to the financial institution processor. Other information can also be transmitted to the financial institution processor as part of the POS transaction. For example, the POS switch can be configured to forward an account identifier from the POS switch to the financial institution processor.

Upon approval of the POS transaction (e.g., the financial institution processor verifies that the user has sufficient funds (of any type) in the user's financial account), the financial institution processor is configured to transmit the transaction approval from the financial institution processor to the POS switch, and the POS switch is configured to forward the transaction approval from the POS switch to the financial transaction system 16. If non-cash-based funds are being used by the user to conduct the POS transaction, the financial transaction system 16 can convert the funds into their cash equivalent for purposes of completing the transaction. Thus, according to exemplary embodiments, users can access alternative non-cash-based financial accounts, such as, for example, frequent flier miles or prepaid telephone cards, to purchase items of an equivalent cash value. Once the POS transaction is complete, the POS device is configured to transmit a transmission complete indication from the POS device to the financial institution processor.

According to an alternative exemplary embodiment, the financial transaction device 12 comprises a point-of-sale (POS) device for forming a financial transaction. The financial transaction is formed between a payor (e.g., a user) and a payee (e.g., a merchant). A POS terminal is associated with the payee, and the POS terminal is electronically coupled to the financial transaction system 16 (e.g., via a network connection or the like). The financial transaction can comprise, for example, a transaction amount, a payor identifier, a payee identifier, and at least one payor financial account identifier. The POS terminal is configured to transmit, to the financial transaction system 16, the transaction amount, the payor identifier, the payee identifier, at least one payor financial account identifier, or the like. The financial transaction system 16 is configured to register contact information of the payor and at least one payor financial account identifier. The contact information is associated with the communication device 14 of the payor. The financial transaction system 16 is configured to receive the transaction amount, the payor identifier, the payee identifier, and at least one payor financial account identifier, and configured to contact the payor using the communication device 14 of the payor. The payor authorizes an electronic payment using the communication device 14 of the payor.

According to this alternative exemplary embodiment, the financial transaction system is configured to transmit the transaction amount from the financial transaction system to the payor via the communication device 14 of the payor. The financial transaction system 16 is configured to transmit the payee identifier from the financial transaction system 16 to the payor via the communication device 14 of the payor. The financial transaction system 16 is also configured to register the payor identifier, and to receive the payor identifier from the communication device 14 of the payor. The financial transaction system 16 is configured to verify that the payor identifier is associated with the at least one payor financial account identifier. The payor identifier can comprise, for example, a plurality of alphanumeric characters that are transmitted to the financial transaction system 16 by pressing a keypad 32 associated with the communication device 14 of the payor. Additionally, the financial transaction system 16 is configured to transmit to a POS switch the at least one payor financial account identifier and the transaction amount. The POS switch is configured to transmit, from the POS switch to a financial transaction processor associated with the at least one payor financial account identifier, the at least one payor financial account identifier and the transaction amount.

According to this alternative exemplary embodiment, once it has been determined that the payor has sufficient funds available to cover the financial transaction, the financial institution processor is configured to transmit, to the financial transaction system 16, a response indicating that the financial transaction is authorized by the financial institution processor. The financial transaction system 16 is configured to transmit to the payee a message associated with the response indicating that the financial transaction is authorized by the financial institution processor. Consequently, the financial transaction system 16 is configured to transmit the transaction amount and the payor identification to the communication device of the payor, and configured to transmit information associated with the payor account to the communication device of the payor.

However, the payor can cancel the POS transaction before the transaction is complete, for example, if the payor decides not to wish to purchase the good or service. Thus, the communication device 14 is configured to transmit a cancellation response to the financial transaction system 16, when the payor decides to cancel the financial transaction. The cancellation response can be any type of message that indicates to the financial institution processor that the transaction is to be terminated. The cancellation response can be an alphanumeric sequence (e.g., one or more buttons) entered into, for example, the keypad 32 of the communication device 14 or a voice command entered into the microphone 36 of the communication device 14.

If the payor continues with the transaction and the transaction is authorized, the financial transaction system 16 is configured to debit the transaction amount from a financial account associated with the at least one payor financial account identifier (e.g., an account number of a checking or savings account, a frequent flier number, and the like). In addition, the financial transaction system is configured to credit the transaction amount to a financial account associated with the payee so that the payee can be paid for the, for example, goods and/or services purchased by the payor.

According to this alternative exemplary embodiment, a payor can re-register with the financial transaction system 16, for example, to update information associated with the payor. Thus, the financial transaction device 12 is configured to compare contact information and at least one payor financial account identifier of the payor (e.g., an financial account number) against stored contact information and at least one payor financial account identifier of the payor. If a match occurs, the financial transaction system is notified that the payor has re-registered. The financial transaction system 16 can also be configured to register a biometric sample of the payor, for example, a payor voice print, a payor fingerprint, a payor facial scan, a payor retinal scan, a payor iris scan, or the like. Consequently, the communication device 14 can be configured to transmit a voice of the payor to the financial transaction system 16 for comparison to the payor voice print stored, for example, in memory 24.

According to an alternative exemplary embodiment, the financial transaction device 12 comprises a point-of-sale (POS) device for forming a financial transaction. According to this alternative exemplary embodiment, the financial transaction is formed between a payor (e.g., a user) and the payee (e.g., a merchant). The financial transaction comprises a transaction amount, a payor identifier, a payee identifier, a payor contact device identifier associated with the communication device 14 of the payor, and at least one payor financial account identifier. The payor contact device identifier can be, for example, a telephone number, a pager number, or any number or address of the communication device 14 of the payor. The POS device is configured to electronically forward the transaction amount, the payor identifier, the payee identifier and the at least one payor financial account identifier to the financial transaction system. The financial transaction system 16 is configured to contact the payor using the contact device identifier and to receive, from the payor, an authorization of an electronic payment.

According to this alternative exemplary embodiment, the financial transaction system 16 can be configured to transmit to the communication device 14 of the payor at least one reminder based on a purchasing history of the payor. Additionally, the financial transaction system 16 can be configured to transmit to the communication device 14 of the payor at least one reminder message of at least one purchase that the payor was to make. The financial transaction system 16 can be configured to transmit to the communication device 14 of the payor information associated with, for example, future discounts of items associated with the payee. The financial transaction system can be configured to transmit to the communication device 14 of the payor a notification of at least one different item, wherein the at least one different item is less expensive and comparable to at least one item associated with the financial transaction.

According to an alternative exemplary embodiment, the system can include a communication device signal frequency booster, located locally to the financial transaction device, for receiving at least one local communication device signal frequency. The communication device signal frequency booster is configured to transmit the at least one local communication device signal frequency to a remote antenna (e.g., antenna 30, or any geographically remote land-based, sea-based, air-based, or space-based antenna) until an available communication device signal frequency is located, and to initiate communication from the communication device after the available communication device signal frequency is located.

According to this alternative exemplary embodiment, the signal frequency booster can be used in conjunction with existing cellular technology to increase carrier capacity. The signal frequency booster can be place in or near the financial transaction device 14. In use, a user places a call on their cellular phone, the signal frequency booster receives the signal input and sends the signal to the nearest cellular tower on an available signal frequency. If no frequencies are available for that tower, the signal frequency booster will transmit the signal further to another tower. This process is repeated until a frequency is matched. The user is then able to place the call. If an available frequency is found on a tower, but that frequency is different than the frequency used by the cellular telephone, the signal frequency booster will translate the frequency used by the cellular telephone to match the available signal frequency

According to this alternative exemplary embodiment, the at least one local communication device signal frequency is a cellular telephone frequency, although it can be the signal frequency of any radio-frequency communication device. Consequently, the communication device signal frequency booster receives the local communication device signal frequency and transmits the signal on a available signal frequency. Thus, the signal frequency booster scans the available signal frequency spectrum for an available signal frequencies. If the available signal frequency is different than the local communication device signal frequency, the signal frequency booster frequency translates the local communication device signal frequency to match the frequency of the available communication device signal frequency. Any method for frequency translation can be used for translating the frequencies. The financial transaction device then communicates with the financial transaction system using the communication device signal frequency booster.

According to an alternative exemplary embodiment, the system can include a communication device signal frequency booster, located locally to the financial transaction device, for receiving at least one local communication device signal frequency. The communication device signal frequency booster is configured to amplify the at least one local communication device signal frequency, and to transmit the amplified at least one local communication device signal frequency to a remote antenna.

Thus, according to exemplary embodiments, a user approaches a financial transaction device 12 and uses a communications device 14 to call the ATN 42, which is indicated on or near the housing of the financial transaction device 12. The financial transaction system 16 receives the call and the user is identified to the system, for example, using calling party identification (“Caller ID”), with the communications device 14 phone number being stored in the database 28. If the financial transaction system 16 is unable to identify the user in this manner, e.g., if the user is calling from a borrowed communications device, the system can instruct the user to input identification information. The user inputs the identification information and the system verifies that the identification information matches the user. The financial transaction system 16 can receive input, for example, via the IVR module 22 or by DTMF input on the keypad 32 of the communication device 14. If no user match is made, the financial transaction system 16 can generate an input error and again request the user to input identification information. If no match is made after a pre-determined number of inputs or periods of time, a timeout can be triggered and the session can be terminated. However, if a match is made and the user is identified, the user can then be asked to input, for example, a PIN or other user security information. The PIN can be communicated to the financial transaction system 16 via the keypad 46 of the financial transaction device 12, the keypad 32 of the communication device 14, or the IVR. The user can also be identified by biometric means, such as voice identification, without necessitating the input of other identification information.

Once a user has been identified, the financial transaction system 16 can request (e.g., using IVR) the user to input their PIN. If the PIN is valid, the transaction system can initiate communication between the communication device 14 and the financial transaction device 12, and provide the user's financial institution account information to the financial transaction device 12. That is, the financial transaction system 16 can provide to the financial transaction device 12 any or all of the information typically contained on, for example, the magnetic stripe of a financial institution access card. If the PIN is invalid, the financial transaction system 16 can generate an error and request the user to again input the PIN, until a valid PIN in entered or timeout occurs. After the financial transaction device 12 receives the financial account information from the financial transaction system 16, the financial transaction device 12 operates as if a financial institution account access card has been inserted into the financial transaction device 12.

Once the user's identification has been verified, the user can be asked to input the UIN 44 of the financial transaction device 12 at which they would like to conduct a transaction. It is appreciated that the user may mistakenly enter a UIN, which, although technically valid, is for a financial transaction device 12 other than the one at which the user is located. In view thereof, after communication is initiated between the financial transaction system 16 and the financial transaction device 12, the financial transaction system 16 can provide a message to the user that states that communication has been initiated. At this point the user will see a request on the display 48 of the financial transaction device 12 to input a one-time transaction PIN. The user can input this PIN on the communications device 14, on the keypad 46 of the financial transaction device 12, or speak into the microphone 36 to use the IVR. If the PIN is input correctly, the financial transaction can proceed. If not, the financial transaction is ended.

Once the financial transaction device 12 location is verified, the user can perform any transaction permitted at the financial transaction device 12, for example, withdraw cash, check balances, transfer funds, purchase items, and the like. All of these transactions are possible without the use of a traditional financial institution access card. After the transaction is complete, a receipt is optionally printed and the communication between the financial transaction system 16 and the financial transaction device 12 is ended.

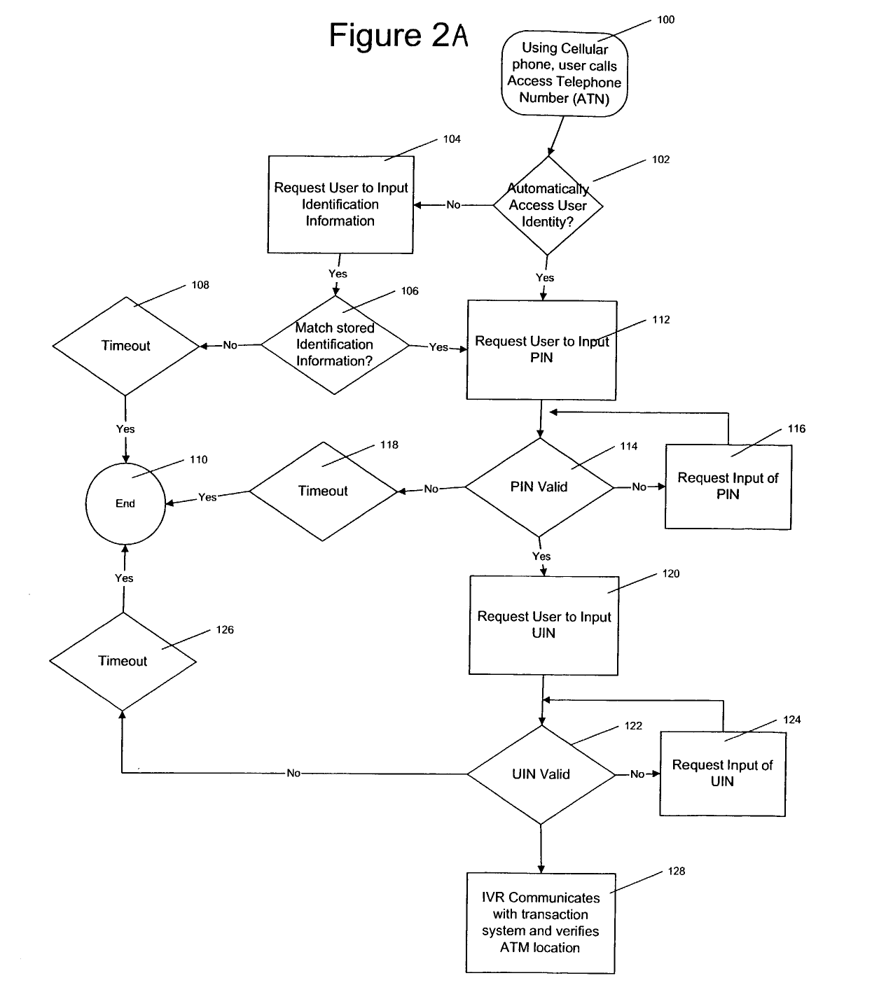

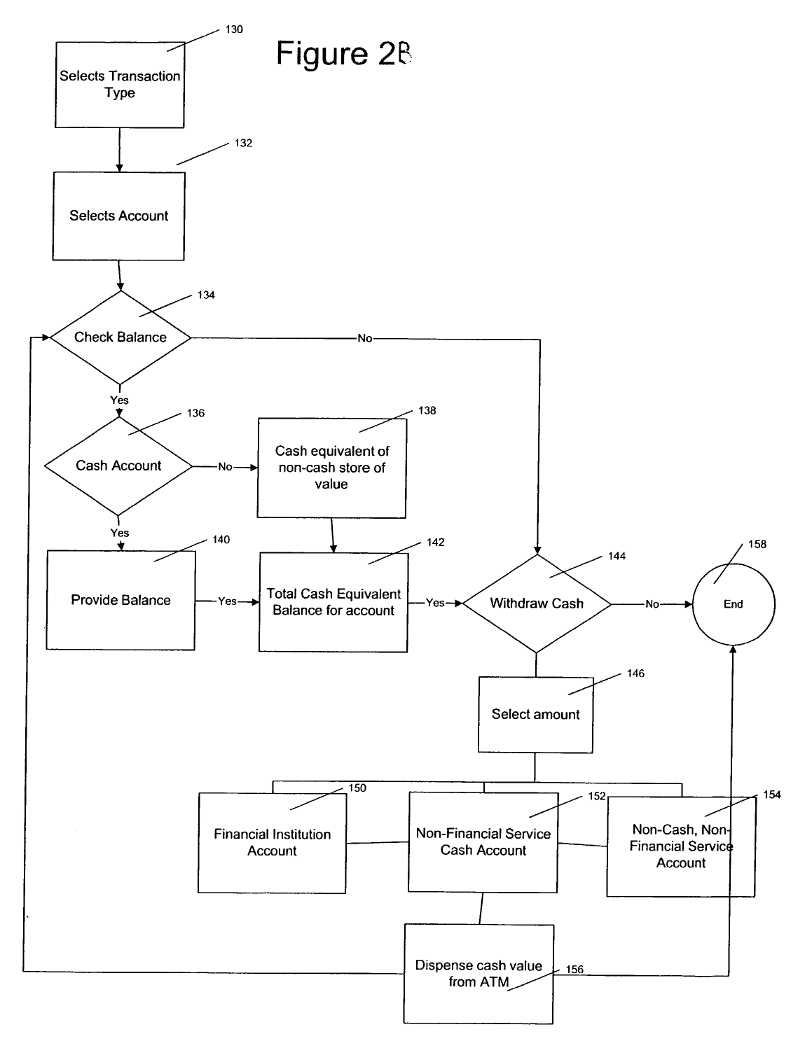

FIGS. 2A and 2B are a flowcharts illustrating steps for user interaction with a financial transaction device in an absence of a financial account access card, in accordance with an exemplary embodiment of the present invention. In step 100 of FIG. 2A, using a communication device (e.g., a cellular phone), the user calls the Access Telephone Number (ATN). In step 102, the user is identified. If automatically identified, in step 112, the user inputs their personal identification number (PIN). If not automatically identified, in step 104, the user inputs their user identification number. In step 106, the user's identification information is matched to the information stored in the transaction system. If the identification is correctly matched, in step 112 the user inputs their PIN. If the identification is not correctly matched, in step 108, the transaction system times out, and, in step 110, the user session is ended.

In step 114, the PIN is validated by the transaction system. If the PIN is valid, in Step 120 the user inputs the unique identification number (UIN) of the ATM. If the PIN is not valid, in step 116 the user inputs their PIN again. In step 122, the UIN is verified. If the UIN is not valid, in step 124, the user inputs the UIN again. In step 128, the interactive voice response (IVR) communicates with the transaction system and verifies the location of the financial transaction device (e.g., the ATM). Throughout the transaction, if user or financial transaction device information is not valid, the transaction system will timeout and the transaction will be ended in one of steps 108, 118, and 126.

Continuing with the transaction in FIG. 2B, once the user and financial transaction device have been validated, in step 130 the user selects a transaction type. In step 132, the user selects the financial account from which the funds should be dispensed. In step 134, the user has the option to check the balance of one or more selected financial accounts. If the user decides to check the balance, in step 136, the user chooses a cash account, or, in step 138, the user chooses a cash-equivalent non-cash store of value. If the account is cash based, in step 140, the transaction system receives the balance from the issuing financial institution and provides the balance to the user. If the account is a non-cash account, in step 138, the transaction system can also indicate the cash-equivalent value of the account. For example, frequent flier miles may have a cash redemption value of one penny per mile, in which case a frequent flier balance of 10,000 miles would be indicated to have a cash value of one hundred dollars. As another example, for a prepaid phone account, the cash value remaining on the card, or the cash value of the minutes remaining would be provided. Alternatively, the transaction system can automatically look up account balances across several accounts even before the user makes a transaction request, and then present the values of the accounts when requested by the user.

In step 144, the user is provided with the option to withdraw cash up to the cash balance (or cash value) of the selected account. In step 146, the user selects the specific amount of cash the user would like to withdraw. If the account selected is a cash-based financial institution account, the transaction is conducted in step 150. If the account is a cash-based, non-financial institution account, the transaction is conducted in step 152. If the account selected is a non-cash, non-financial institution account, the transaction is conducted in step 154. For all types of accounts, in step 156, the cash or cash equivalent is dispensed from the financial transaction device.

According to exemplary embodiments, from the user's perspective, the steps required to withdraw cash at a financial transaction device are substantially the same regardless of the whether the account is a financial institution account, another cash-based account, or a non-cash-based account. However, for both cash and non-cash stores of value other than traditional financial institution accounts, it may be necessary for the system to additionally communicate with the company holding the stores of value for reconciliation and to translate or convert the non-cash-based store of value into a cash equivalent.

As an alternative, in step 134, the user need not elect to check balances prior to withdrawing cash at step 144. That is, the user may be aware that sufficient cash or other value is provided in the selected account for the desired withdrawal, and skip the balance check. The transaction system can confirm the sufficiency of funds from the primary account, or if sufficient funds exist across several accounts, the transaction system can query the user as to from which accounts funds should be withdrawn.

If the user does not wish at step 134 to check balances or at step 144 to withdraw cash, the services are terminated at 158. Likewise, services are terminated at 158 after a cash withdrawal transaction is completed. Optionally, the user may return to step 134 to check account balances after step 156 when cash or the cash equivalent is dispensed from the financial transaction device.

According to exemplary embodiments, even without an account at a traditional financial institution, a user can call an access telephone number, input a UIN, and select another type of stored value from an account stored in the user's account information, and request that a particular dollar amount of the non-cash stored value be converted into cash and dispensed at the ATM.

According to an alternative exemplary embodiment, the financial transaction can be initiated by the financial transaction device. For example, a user can input a financial access card into a financial transaction device. With the identifying information on the card, the financial transaction device can then contact the user via a communication device to request, for example, additional identifying information (e.g., a voice print or alphanumeric sequence). The identification of the financial transaction device need not be entered by the user at this point. For example, once the user input their card into the machine, the financial transaction device can contact the transaction system and relay information that identifies the financial transaction device and the user. The transaction system can then determine the location of the financial transaction device. The transaction system can also determine the location of the user, as the user is in the local vicinity of the financial transaction device to use the device. The transaction system can then contact the user via the communication device of the user. Once contacted and the additional information is received from the user via the communication device, the user can continue the financial transaction at the financial transaction device using the financial transaction device or the communication device of the user.

Alternatively, the transaction system can triangulate the position of the user using the communication device of the user. Triangulation of communication devices (e.g., cellular telephones) is known to those of ordinary skill in the art. If the transaction system determines that a user is passing near a financial transaction device, the transaction system can contact the user via the user's communication device to request whether the user wishes to conduct a financial transaction at the financial transaction device that is located near the user. If so desired, the user can conduct the financial transaction at the financial transaction device or via the communication device.

The steps of a computer program as illustrated in FIG. 2A and 2B for conducting a financial transaction using a communications device can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A system for conducting a financial transaction using a communication device, comprising:
a communication device for transmitting user identification information to identify a user and for transmitting a unit identification number;
a financial transaction system for receiving the user identification information and the unit identification number from the communication device, wherein the financial transaction system is contacted using an access calling number;
a financial transaction device that communicates with the financial transaction system,
wherein the unit identification number is associated with the financial transaction device,
wherein the financial transaction device is contacted via the communication device,
wherein the access calling number enables communication with the financial transaction device using the communication device,
wherein the financial transaction system is configured to transmit financial information associated with the user to the financial transaction device associated with the unit identification number, and
wherein a financial transaction is conducted with the financial transaction device in the absence of use of a financial account access card, upon receipt by the financial transaction device of the financial information associated with the user.

2. The system of claim 1, wherein access calling number is located locally to the financial transaction device.

3. The system of claim 1, wherein the unit identification number is located locally to the financial transaction device.

4. The system of claim 1, wherein each of the access calling number and the unit identification number comprises a tactile-sensed structure.

5. The system of claim 1, wherein the unit identification number is unique to each financial transaction device.

6. The system of claim 1, wherein the financial transaction system is configured to verify an identity of the user using the user identification information.

7. The system of claim 1, wherein the user identification information comprises a calling party identification associated with the communication device.

8. The system of claim 1, wherein the user identification information comprises biometric information unique to the user.

9. The system of claim 1, wherein financial transaction system is configured to access the financial information associated with the user from at least one financial information database.

10. The system of claim 9, wherein the financial information associated with the user is accessed based on an identification of the communication device.

11. The system of claim 1, wherein the financial transaction system is configured to associate the unit identification number with a host identification to identify the financial transaction device to which to transmit the financial information.

12. The system of claim 1, wherein the user conducts the financial transaction using the financial transaction device.

13. The system of claim 1, wherein the user conducts the financial transaction using the communication device.

14. The system of claim 1, wherein the financial transaction device is configured to allow the user to withdraw cash from the financial transaction device.

15. The system of claim 1, wherein the financial transaction device is configured to allow the user to determine a balance of a financial account.

16. The system of claim 1, wherein the financial transaction device is configured to allow the user to purchase at least one of a good and a service.

17. The system of claim 1, the financial transaction device is configured to allow the user to access a store of value.

18. The system of claim 17, wherein the communication device is configured to provide, by the user, a user account security identification associated with the store of value.

19. The system of claim 1, wherein the financial transaction device comprises a point-of-sale (POS) device,
wherein the POS device is configured to enter a transaction amount and a communication device access number and configured to forward the transaction amount and the communication device access number to the financial transaction system,
wherein the financial transaction system is configured to contact the communication device associated with the communication device access number for transaction authorization, to contact a financial institution processor for a transaction verification, and to issue a transaction approval to the POS device, after receiving a transaction authorization from the communication device and after receiving the transaction verification from the financial institution processor.

20. The system of claim 19, wherein the financial transaction system is configured to transmit at least one of a transaction amount, a merchant identifier, a date, a time, and a remaining balance in a financial account associated with the user.

21. The system of claim 19, wherein the financial institution processor is configured to forward the transaction verification from the financial institution processor to a POS switch, and the POS switch is configured to forward the transaction verification from the POS switch to the financial transaction system.

22. The system of claim 19, wherein the financial institution processor is configured to debit a financial account associated with the user for a financial transaction amount, and to credit a financial account associated with a merchant for the financial transaction amount.

23. The system of claim 19, comprising:
a cash register associated with the POS device, wherein the cash register is configured to enter at least one of the transaction amount and the communication device access number.

24. The system of claim 19, comprising:
a telecommunication network for communication of information between the communication device and the financial transaction system.

25. The system of claim 19, wherein the financial transaction system is configured to forward the transaction amount from the financial transaction system to a POS switch, and the POS switch is configured to forward the transaction amount from the POS switch to the financial institution processor.

26. The system of claim 25, wherein the POS switch is configured to forward an account identifier from the POS switch to the financial institution processor.

27. The system of claim 26, wherein the financial institution processor is configured to transmit the transaction approval from the financial institution processor to the POS switch, and the POS switch is configured to forward the transaction approval from the POS switch to the financial transaction system.

28. The system of claim 19, wherein the POS device is configured to transmit a transmission complete indication from the POS device to the financial institution processor.

29. The system of claim 1, comprising:
a point-of-sale (POS) device for forming a financial transaction, wherein the financial transaction is formed between a payor and a payee, the financial transaction comprising a transaction amount, a payor identifier, a payee identifier, and the at least one payor financial account identifier,
wherein the financial transaction system is configured to register contact information of the payor and at least one payor financial account identifier, wherein the contact information is associated with the communication device of the payor, and configured to receive the transaction amount, the payor identifier, the payee identifier, and the at least one payor financial account identifier, and configured to contact the payor using the communication device of the payor, wherein the payor authorizes an electronic payment using the communication device of the payor.

30. The system of claim 29, wherein financial transaction system is configured to transmit the transaction amount from the financial transaction system to the payor via the communication device of the payor.

31. The system of claim 29, wherein financial transaction system is configured to transmit the payee identifier from the financial transaction system to the payor via the communication device of the payor.

32. The system of claim 29, wherein the financial transaction system is configured to register the payor identifier, and to receive the payor identifier from the communication device of the payor.

33. The system of claim 29, wherein the financial transaction system is configured to verify that the payor identifier is associated with the at least one payor financial account identifier.

34. The system of claim 29, wherein the financial transaction system is configured to transmit to a POS switch the at least one payor financial account identifier and the transaction amount, and wherein the POS switch is configured to transmit, from the POS switch to a financial transaction processor associated with the at least one payor financial account identifier, the at least one payor financial account identifier and the transaction amount.

35 The system of claim 34, wherein the financial institution processor is configured to transmit, to the financial transaction system, a response indicating that the financial transaction is authorized by the financial institution processor, and
wherein the financial transaction system is configured to transmit to the payee a message associated with the response indicating that the financial transaction is authorized by the financial institution processor.

36. The system of claim 29, wherein the financial transaction system is configured to transmit the transaction amount and the payor identification to the communication device of the payor.

37. The system of claim 36, wherein the financial transaction system is configured to transmit information associated with the payor account to the communication device of the payor.

38. The system of claim 29, wherein the communication device is configured to transmit a cancellation message to the financial transaction system, when the payor decides to cancel the financial transaction.

39. The system of claim 29, wherein the financial transaction system is configured to register a biometric sample of the payor.

40. The system of claim 29, wherein the financial transaction system is configured to debit the transaction amount from a financial account associated with the at least one payor financial account identifier.

41. The system of claim 40, wherein the financial transaction system is configured to credit the transaction amount to a financial account associated with the payee.

42. The system of claim 29, wherein the financial transaction device is configured to compare contact information and at least one payor financial account identifier of the payor against stored contact information and at least one payor financial account identifier of the payor, wherein if a match occurs, the financial transaction system is notified that the payor has updated registration information.

43. The system of claim 1, comprising:
a point-of-sale (POS) device for forming a financial transaction, wherein the financial transaction is formed between a payor and the payee, wherein the financial transaction comprises a transaction amount, a payor identifier, a payee identifier, a payor contact device identifier associated with the communication device of the payor, and at least one payor financial account identifier, wherein the POS device is configured to electronically forward the transaction amount, the payor identifier, the payee identifier and the at least one payor financial account identifier to the financial transaction system, and
wherein the financial transaction system is configured to contact the payor using the contact device identifier and to receive, from the payor, an authorization of an electronic payment.

44. The system of claim 1, comprising:
a communication device signal frequency booster, located locally to the financial transaction device, for receiving at least one local communication device signal frequency, wherein the communication device signal frequency booster is configured to transmit the at least one local communication device signal frequency to a remote antenna until an available communication device signal frequency is located, and to initiate communication from the communication device after the available communication device signal frequency is located.

45. The system of claim 44, wherein the financial transaction device communicates with the financial transaction system using the communication device signal frequency booster.

46. The system claim 1, comprising:
a communication device signal frequency booster, located locally to the financial transaction device, for receiving at least one local communication device signal frequency, wherein the communication device signal frequency booster is configured to amplify the at least one local communication device signal frequency, and to transmit the amplified at least one local communication device signal frequency to a remote antenna.

47. A method for conducting a financial transaction using a communication device, comprising the steps of:
contacting a financial transaction system associated with a financial transaction device via the communication device, wherein the financial transaction system is contacted using an access calling number, and wherein the access calling number enables communication with the financial transaction device using the communication device;
transmitting user identification information from the communication device to the financial transaction system to identify a user;
transmitting a unit identification number associated with the financial transaction device from the communication device to the financial transaction system;
transmitting financial information associated with the user from the financial transaction system to the financial transaction device associated with the unit identification number; and
conducting a financial transaction with the financial transaction device in the absence of use of a financial account access card, upon receipt by the financial transaction device of the financial information associated with the user.

48. The method of claim 47, wherein access calling number is located locally to the financial transaction device.

49. The method of claim 47, wherein the unit identification number is located locally to the financial transaction device.

50. The method of claim 47, wherein each of the access calling number and the unit identification number comprises a tactile-sensed structure.

51. The method of claim 47, wherein the unit identification number is unique to each financial transaction device.

52. The method of claim 47, comprising the step of:
verifying an identity of the user using the user identification information.

53. The method of claim 47, wherein the user identification information comprises a calling party identification associated with the communication device.

54. The method of claim 47, wherein the user identification information comprises a subscriber number that is unique to the user.

55. The method of claim 47, wherein the user identification information comprises biometric information unique to the user.

56. The method of claim 47, wherein the step of transmitting financial information comprises the step of:
accessing the financial information associated with the user from at least one financial information database.

57. The method of claim 47, wherein the financial information is a bank account number of the user.

58. The method of claim 47, wherein the step of transmitting financial information comprises the step of:
associating, by the financial transaction system, the unit identification number with a host identification to identify the financial transaction device to which to transmit the financial information.

59. The method of claim 47, wherein the step of conducting the financial transaction is performed by the user using the financial transaction device.

60. The method of claim 47, wherein the step of conducting the financial transaction is performed by the user using the communication device.

61. The method of claim 47, wherein the step of conducting a financial transaction comprises the step of:
withdrawing cash from the financial transaction device.

62. The method of claim 47, wherein the step of conducting a financial transaction comprises the step of:
determining a balance of a financial account.

63. The method of claim 47, wherein the step of conducting a financial transaction comprises the step of:
purchasing at least one good.

64. The method of claim 47, wherein the step of conducting a financial transaction comprises the step of:
accessing a store of value.

65. The method of claim 64, wherein the step of accessing a store of value comprises the step of:
providing, by the user, a user account security identification associated with the store of value.

66. The method of claim 47, wherein the step of conducting a financial transaction comprises the steps of:
entering a transaction amount and a communication device access number into a point-of-sale (POS) device;
forwarding, by the POS device, the transaction amount and the communication device access number to the financial transaction system;
contacting, by the financial transaction system, the communication device associated with the communication device access number for transaction authorization;
contacting, by the financial transaction system, a financial institution processor for a transaction verification; and
issuing, by the financial transaction system, a transaction approval to the POS device, after receiving a transaction authorization from the communication device and after receiving the transaction verification from the financial institution processor.

67. The method of claim 66, wherein the step of contacting the communication device comprises the step of:
transmitting at least one of a transaction amount, a merchant identifier, a date, a time, and a remaining balance in a financial account associated with the user.

68. The method of claim 66, wherein the step of contacting a financial institution processor comprises the steps of:
forwarding the transaction verification from the financial institution processor to a POS switch; and
forwarding the transaction verification from the POS switch to the financial transaction system.

69. The method of claim 66, wherein the step of contacting a financial institution processor comprises the step of:
debiting a financial account associated with the user for a financial transaction amount; and
crediting a financial account associated with a merchant for the financial transaction amount.

70. The method of claim 66, further comprising the step of:
entering at least one of the transaction amount and the communication device access number into a cash register associated with the POS device.

71. The method of claim 66, wherein the step of contacting a financial institution processor comprises the steps of:
forwarding the transaction amount from the financial transaction system to a POS switch; and
forwarding the transaction amount from the POS switch to the financial institution processor.

72. The method of claim 71, comprising the step of:
forwarding an account identifier from the POS switch to the financial institution processor.

73. The method of claim 72, comprising the step of:
transmitting the transaction approval from the financial institution processor to the POS switch; and
forwarding the transaction approval from the POS switch to the financial transaction system.

74. The method of claim 66, comprising the step of:
transmitting a transmission complete indication from the POS device to the financial institution processor.

75. The method of claim 72, wherein the step of conducting a financial transaction comprises the steps of:
a payor registration step, wherein a payor registers contact information and at least one payor financial account identifier with the financial transaction system, and wherein the contact information is associated with the communication device of the payor;
a transaction formation step, wherein a financial transaction is formed between the payor and a payee, the financial transaction comprising a transaction amount, a payor identifier, a payee identifier, and the at least one payor financial account identifier;
at least one transmission step, wherein the transaction amount, the payor identifier, the payee identifier, and the at least one payor financial account identifier are electronically forwarded to the financial transaction system; and
a payor authorization step, wherein the financial transaction system contacts the payor using the communication device of the payor, and wherein the payor authorizes an electronic payment using the communication device of the payor.

76. The method of claim 75, wherein the payor authorization step comprises the step of:
transmitting the transaction amount from the financial transaction system to the payor via the communication device of the payor.

77. The method of claim 75, wherein the payor authorization step comprises the step of:
transmitting the payee identifier from the financial transaction system to the payor via the communication device of the payor.

78. The method of claim 75, comprising the step of:
registering the payor identifier with the financial transaction system, during the payor registration step; and
transmitting the payor identifier from the communication device of the payor to the financial transaction system, during the payor authorization step.

79. The method of claim 75, comprising the step of:
verifying, by the financial transaction system, that the payor identifier is associated with the at least one payor financial account identifier.

80. The method of claim 75, comprising the step of:
transmitting, from the financial transaction system to a point-of-sale (POS) switch, the at least one payor financial account identifier and the transaction amount; and
transmitting, from the POS switch to a financial transaction processor associated with the at least one payor financial account identifier, the at least one payor financial account identifier and the transaction amount.

81. The method of claim 80, comprising the step of:
transmitting, from the financial institution processor to the financial transaction system, a response indicating that the financial transaction is authorized by the financial institution processor; and
transmitting, from the financial transaction system to the payee, a message associated with the response indicating that the financial transaction is authorized by the financial institution processor.

82. The method of claim 75, wherein the payor authorization step comprises the step of:
transmitting, by the financial transaction system, the transaction amount and the payor identification to the communication device of the payor.

83. The method of claim 82, wherein the payor authorization step comprises the step of:
transmitting, by the financial transaction system, information associated with the payor account to the communication device of the payor.

84. The method of claim 75, comprising the step of:
transmitting a cancellation response from the communication device of the payor to the financial transaction system, when the payor decides to cancel the financial transaction.

85. The method of claim 75, comprising the step of:
a transaction payment step, wherein the transaction amount is debited from a financial account associated with the at least one payor financial account identifier.

86. The method of claim 85, wherein the transaction amount is credited to a financial account associated with the payee.

87. The method of claim 75, comprising the step of:
a payor re-registration step, wherein contact information and at least one payor financial account identifier of the payor are compared against stored contact information and at least one payor financial account identifier of the payor, wherein if a match occurs, the financial transaction system is notified that the payor has re-registered.

88. The method of claim 47, comprising the steps of:
a transaction formation step, wherein a financial transaction is formed between the payor and the payee, wherein the financial transaction comprises a transaction amount, a payor identifier, a payee identifier, a payor contact device identifier associated with the communication device of the payor, and at least one payor financial account identifier;
at least one transmission step, wherein the transaction amount, the payor identifier, the payee identifier and the at least one payor financial account identifier are electronically forwarded to the financial transaction system; and
a payor authorization step, wherein the financial transaction system contacts the payor using the contact device identifier and the payor authorizes an electronic payment.
